(19) United States
(12) Patent Application Publication
(10) Pub. No.: US 2026/0285018 A1
(43) Pub. Date: Sep. 24, 2026

(54) HIGH PUNCTURE RESISTANT AND HIGH TOUGHNESS RECYCLABLE PACKAGING FILM USING POLAR POLYMER FILM

(71) Applicant: PROAMPAC HOLDINGS INC., Cincinnati, OH (US)

(72) Inventors: Seyed Hesamoddin Tabatabaei, Mason, OH (US); Amir Saffar, Laval (CA)

(21) Appl. No.: 19/573,075

(22) Filed: Mar. 20, 2026

Related U.S. Application Data
(60) Provisional application No. 63/775,554, filed on Mar. 21, 2025.

(51) Int. Cl. B32B 27/08; B32B 27/30; B32B 27/32

(52) U.S. Cl. CPC B32B 27/08; B32B 27/306; B32B 27/32; B32B 2250/05; B32B 2255/10; B32B 2255/20; B32B 2307/516; B32B 2307/518; B32B 2307/558; B32B 2307/7244

(57) ABSTRACT

A high toughness, puncture resistant, recyclable, polyolefin-based film structure includes an outer layer having a first surface and second surface, formed of one of: a machine direction oriented polyolefin-based film; and, a biaxially oriented polar polymer film. A middle layer has a first surface and second surface, formed of the other one of: the machine direction oriented polyolefin-based film; and, the biaxially oriented polar polymer film. A first bonding interlayer bonds the second surface of the outer layer to the first surface of the middle layer. An inner layer has a first surface and second surface, the first surface of the inner layer bonded to the second surface middle layer. The inner layer comprises a polyolefin-based polymer, wherein at least the second surface of the inner layer is heat sealable and wherein the second surface of the inner layer defines an innermost surface of the film structure.

### CROSS REFERENCE TO RELATED APPLICATION

This application claims the priority benefit of U.S. Provisional Patent Application No. 63/775,554 filed Mar. 21, 2025. The aforementioned application is incorporated herein by reference in its entirety.

### BACKGROUND

The present invention relates to flexible packaging films and, in particular, to recyclable, high toughness, high puncture resistant laminated film structures using a polar polymer film. The packaging films herein may advantageously be used for packaging containers for sharp products.

High puncture plastic packaging has been a key player in food packaging for sharp products, such as meat with bones, nuts, and pet food. Among different polymers, polyesters, including polyethylene terephthalate (PET) polymers and polyamide polymers, e.g., nylon polymers, are known for their outstanding puncture resistance and are used commonly in puncture resistant barrier packaging. However, it has been shown that recycling of these packages is very challenging due to the presence of PET and Nylon components. Nonpolar polymers such as polyolefins and polar polymers such as nylon, ethylene vinyl alcohol copolymers (EVOH) and polyesters are generally not compatible in recycling processes due to immiscibility. This incompatibility leads to phase separation when melted during the recycling process where the polar polymers form discrete domains within the nonpolar matrix. These polar domains can aggregate, creating weak points in the recycled material, reducing mechanical properties, and leading to defects in the final product.

Accordingly, there exists a need for an improved high puncture packaging film that enhances recyclability without compromising toughness and puncture resistance.

Various advantages and benefits of the present invention will become apparent to those of ordinary skill in the art upon reading and understanding the following detailed description of the preferred embodiments.

### SUMMARY

In one aspect, the film structure in accordance with the present disclosure comprises 3 films or plies that combine toughness and stiffness needed for packaging and product protection. One of an outer ply and a middle ply is an oriented polyolefin-based film that is uniaxially oriented in the machine direction with a stretch ratio in the machine direction in the range of 3 to 10. The other one of the outer ply and middle ply is an oriented polar polymer-based film that is biaxially oriented with a stretch ratio in the machine direction in the range of 3 to 10 and a stretch ratio in the transverse direction in the range of 3 to 10. An inner layer comprises a polyolefin-based sealant layer, with or without an oxygen barrier layer. In embodiments, the total structure contains at least 70% by weight polyolefin-based polymer. In embodiments, the total structure contains at least 75% by weight polyolefin-based polymer. In embodiments, the total structure contains at least 80% by weight polyolefin-based polymer. In embodiments, the total structure contains at least 85% by weight polyolefin-based polymer. In embodiments, the total structure contains at least 90% by weight polyolefin-based polymer. In embodiments, the total structure contains at least 95% by weight polyolefin-based polymer.

In a more limited aspect, the inner sealant layer is selected from a polyolefin-based sealant, polyolefin-based coextruded sealant having a core barrier layer, such as ethylene vinyl alcohol copolymer (EVOH), polyamide (e.g., nylon 6, nylon 66), and polyvinyl alcohol (PVOH). In embodiments, the polyolefin is selected from polyethylene, polypropylene, or blends of polyethylene and polypropylene.

In a more limited aspect, the oriented polyolefin-based film that is uniaxially oriented in the machine direction is configured to provide directional tear in the machine direction, wherein the tear resistance in the machine direction is less than 100 gf/mil when measured in accordance with according to ASTM D1922

In another more limited aspect, the biaxially oriented polar polymer-based film has a maximum puncture force which is greater than 15 N when measured in accordance with ASTM F1306.

In another more limited aspect, the overall film structure has a maximum puncture force which is greater than 20 N when measured in accordance with ASTM F1306.

In embodiments, an optional coating layer may be applied to the outer surface of the outer layer. In embodiments, the coating layer is selected from an energy cured coating and two-part coating.

In another more limited aspect, packaging articles formed of the film structures herein are provided.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a generalized side cross-sectional view illustrating the laminated packaging film in accordance with the present disclosure.

FIGS. 2A-2F are side cross-sectional views illustrating exemplary laminated film structures in accordance with the present disclosure wherein the outer layer is a machine direction oriented (MDO) polyolefin-based film and the middle layer is a biaxially oriented polar polymer-based film.

FIGS. 3A-3F are side cross-sectional views illustrating exemplary laminated film structures in accordance with the present disclosure wherein the outer layer is a biaxially oriented polar-polymer-based film and the middle layer is a machine direction oriented (MDO) polyolefin-based film.

FIG. 4A is a side cross-sectional view illustrating an exemplary nonbarrier sealant layer.

FIG. 4B is a side cross-sectional view illustrating a first exemplary barrier sealant layer.

FIG. 4C is a side cross-sectional view illustrating a second exemplary barrier sealant layer.

FIG. 4D is a side cross-sectional view illustrating a third exemplary barrier sealant layer.

FIG. 4E is a side cross-sectional view illustrating a fourth exemplary barrier sealant layer.

FIG. 5A is a flow chart illustrating a first exemplary method in accordance with the present disclosure.

FIG. 5B is a flow chart illustrating a second exemplary method in accordance with the present disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The term “directly contacts,” “in direct contact with,” “directly adhered to,” or similar terms as used herein, refers to a layer configuration whereby a first layer is located immediately adjacent to a second layer, the first layer touches the second layer, and no intervening layers, and/or no intervening structures, are present between the first layer and the second layer. The terms “indirectly contacts” or “in indirect contact with,” or similar terms as used herein, refers to a layer configuration whereby an intervening layer, or an intervening structure, is present between the first layer and the second layer.

As used in this application, the terms “front,” “rear,” “upper,” “lower,” “upwardly,” “downwardly,” “left,” “right,” and other orientation descriptors are intended to facilitate the description of the exemplary embodiment(s) of the present invention and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to +0.01%, from the specified amount, as such variations are appropriate in the disclosed materials and methods.

The terms “outer” and “inner” are used herein to refer to a position in relation to a product to be packaged using the multilayer packaging structures herein, while the terms “exterior” and “interior” are used herein to refer to a position in relation to other layers of the multilayer packaging structures herein.

As used herein, the term “outer” in connection with a layer or a ply refers to a layer or ply of a multilayer packaging structure which is furthest from the product to be packaged in relation to the other layers of the multilayer structure. The term “outward facing surface” of a layer of a multilayer packaging structure is the surface of such layer that faces away from the product being packaged within a multilayer packaging structure herein or a packaging article formed thereof. The term “outer surface” of a multilayer packaging structure is the surface of the structure that is intended to face away from a product being packaged within the structure.

As used herein, the term “inner” in connection with a layer or a ply refers to a layer or ply of a multilayer packaging structure which is closest to or is intended to contact the product to be packaged within a multilayer structure herein in relation to the other layers of the multilayer structure. The term “inward facing surface” of a layer or ply of a multilayer packaging structure herein is the surface of such layer that is intended to face toward the product being packaged within a multilayer packaging structure herein or a packaging article formed thereof. The term “inner surface” of a multilayer packaging structure herein is the surface of the structure that faces toward or is intended to face toward or contact a product being packaged within the structure.

As used herein, the term “interior” in connection with a layer or a ply refers to a layer or ply within a multilayer packaging structure herein is that is not exposed to handling and the environment. Interior layers may provide functionality as needed for particular applications. For example, interior layers may provide barrier protection and/or structural strength. As an example, an exemplary interior layer provides protection to packaged food or other product for freshness and/or a barrier to moisture and/or oxygen, and/or a barrier to migration of moisture, oils, and the like from packaged food or other product from the inner surface of the multilayer packaging structure to the outer surface of the multilayer packaging structure. As another example, an interior layer may also be a structural layer which provides one or more properties including but not limited to general durability, puncture strength, resistance to deformation, tear or flex crack resistance, and the like.

As used herein, the term “exterior” in connection with a layer or a ply refers to a layer or ply which comes in immediate contact with the outside environment or atmosphere. Therefore, the multilayer packaging structures herein have two exterior layers, namely, the inner layer and the outer layer.

As used herein, the term “extrusion” is used with reference to the process of forming shapes such as a melt curtain by forcing a molten plastic material through a die, followed by cooling or chemical hardening. Immediately prior to extrusion through the die, the polymeric material is fed into a rotating screw, i.e., an extruder that forces the polymeric material through the die. The term “continuous extrusion” refers to an extrusion process wherein the die is designed to produce a continuous flow or curtain of molten polymer without breaks or gaps. The term “discontinuous extrusion” refers to an extrusion process wherein the die is designed to produce a patterned or otherwise discontinuous flow or curtain of molten polymer. For example, the die may have multiple orifices that allow the polymer to be extruded in a pattern or with gaps in between extruded portions.

As used herein, the term “extrusion coating” is used in reference to a process wherein a molten polymer is extruded through a die and applied as a coating onto a substrate to form a coated substrate.

As used herein, the term “extrusion lamination” is used in reference to a process where a molten polymer is extruded through a die and then immediately laminated onto a first substrate and passes through a nip between the extrusion die and a second substrate, wherein the molten polymer forms an extrusion interlayer and bonds the two substrates together to form a laminated structure.

As used herein, the term “coextrusion” refers to the process of extruding two or more materials through a single die with two or more orifices arranged so that the extrudates merge and weld together into a laminar structure before chilling, i.e., quenching.

As used herein, the terms “packaging structure,” “packaging film structure,” and the like refer to a web of sheet material having a structure as disclosed herein, as well as a packaging article manufactured therefrom, including sheets or wraps, bags, pouches, and the like.

As used herein, the term “film” refers to a continuous layer or component of material that contributes to the structure or function of a multilayer structure. A film may be formed via processes such as extrusion, coextrusion, casting, coating, or other techniques, including the drying or curing of applied dispersions. A film may exist as a single layer or comprise multiple sublayers and may be used independently or as part of a composite structure.

As used herein, the term “ply” refers to any discrete component of a multilayer film that contributes to the structure or function of the film, including, but not limited to, layers formed via extrusion, coextrusion, melt-applied techniques, lamination, or other methods. A ply may itself comprise one or more sublayers.

As used herein, the term “polar polymer” refers to a polymer that contains electronegative groups or polar functional groups such as hydroxyl groups, carbonyl groups, carboxyl groups, carboxylate groups, ester groups, amide groups, ether groups, nitrile groups, or similar groups. These groups impart polarity to the polymer, such as an ability to form hydrogen bonds or polar/polar interactions, resulting in an increased affinity for polar substances. Examples of polar polymers include, but are not limited to, polyamides, ethylene vinyl alcohol copolymer (EVOH), polyesters, acrylates, and copolymers or blends thereof.

As used herein, the term “oriented” refers to polymer films that have been subjected to a stretching process either during film extrusion or post-extrusion to align the polymer chains in one or more directions. The term includes both monoaxially oriented films, where the polymer chains are aligned predominantly in one direction, and biaxially oriented films, where the polymer chains are aligned in two perpendicular directions. Oriented films are typically characterized by one or more improved mechanical properties, such as strength, clarity, tensile strength, heat resistance, abrasion resistance, puncture resistance, barrier properties, dimensional stability, and improved performance in Gelbo Flex testing, as compared to non-oriented films.

As used herein, the term “polyolefin-based film” refers to a film comprising one or more polyolefins, including homopolymers, copolymers, and blends thereof. Polyolefins include, but are not limited to, polyethylene (PE), polypropylene (PP), polybutene (PB), and their copolymers (e.g., ethylene-propylene copolymers, ethylene-butene copolymers).

In embodiments, the polyolefin-based film may include compatibilizers, functional or functionalized polyolefins (including but not limited to polyolefins grafted with carboxylic acids or anhydride derivatives, preferably polyolefins grafted with lower carboxylic acids or lower anhydride derivatives, including but not limited to polyethylene (PE) grafted with acrylic acid (AA) (PE-g-AA), polyethylene (PE) grafted with maleic anhydride (MA) (PE-g-MA) polyethylene (PE) grafted with methacrylic acid (MAA) (PE-g-MAA), polypropylene (PP) grafted with acrylic acid (AA) (PP-g-AA), polypropylene (PP) grafted with maleic anhydride (MA) (PP-g-MA), and polypropylene (PP) grafted with methacrylic acid (MAA) (PP-g-MAA), or other modified polyolefins configured to enhance adhesion and/or compatibility), as well as additional components such as fillers or other additives, provided that polyolefin remains the predominant polymeric component of the film.

As used herein, the term “compatibilizer” refers to a composition configured to enhance the miscibility or compatibility of polar and nonpolar polymers and reduce the aggregation of polar polymer phase domains within a nonpolar polymer matrix. This improved compatibility facilitates the formation of more homogeneous blends during melting and extrusion stages of the recycling process, enabling the efficient reprocessing of polymer materials containing both nonpolar and polar polymer components.

All compositional percentages used herein are presented on a “by weight” basis, unless specifically stated otherwise.

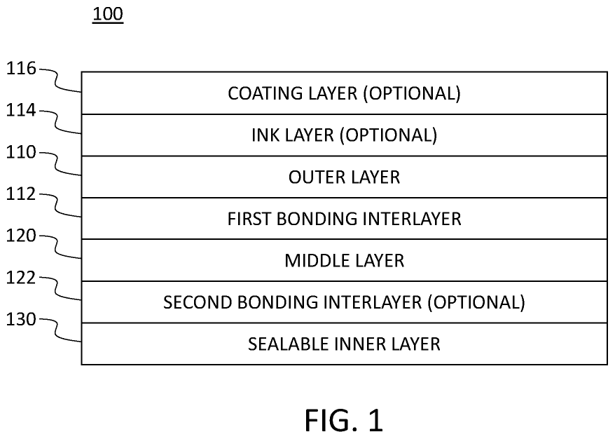

Referring now to FIG. 1, there is shown an exemplary packaging film structure 100 which includes an outer film layer 110 which is laminated to a middle film layer 120. The middle film layer, in turn, is bonded to an inner sealant layer 130. The outer layer 110 and the middle layer 120 are laminated via a first bonding interlayer 112 disposed intermediate the outer layer 110 and the middle layer 120. The middle layer 120 and the sealant layer 130 are bonded together by a bonding method selected from (1) a second bonding interlayer 122 disposed between the middle layer 120 and the sealant layer 130; and (2) direct bonding, wherein the sealant layer 130 is applied directly onto the middle layer 120 by an extrusion coating or coextrusion coating process.

In embodiments, one or both major surfaces of the outer film layer 110 and/or the middle layer 120 may optionally have a gas and/or moisture barrier coating thereon. The optional barrier coating may be an inorganic barrier or polymeric barrier. In certain embodiments, when applied to the middle layer 120, the barrier coating comprises an inorganic barrier material including but not limited to inorganic oxides such as aluminum oxide (AlOx), silicon oxide (SiOx), or a combination thereof, a metallized layer such as aluminum, or a polymeric barrier material including but not limited to ethylene vinyl alcohol copolymer (EVOH), and polyvinyl alcohol (PVOH). In certain embodiments, when applied to the outer layer 110, the barrier coating comprises an inorganic barrier material including but not limited to inorganic oxides such as AlOx, SiOx, or a combination thereof, a metallized layer such as aluminum, or a polymeric barrier material including but not limited to polyvinyl alcohol (PVOH).

When the optional barrier on the outer layer 110 or middle layer 120 is a metallized or inorganic oxide layer, it may be formed using physical or chemical deposition techniques, including but not limited to physical vapor deposition (PVD), chemical vapor deposition (CVD), sputtering, and the like. In certain embodiments, the optional barrier coating may be applied a surface of the outer layer 110 or middle layer 120 using a conventional application technique, including but not limited to flexographic coating, gravure coating, spray coating, roll coating, slot-die coating, curtain coating, extrusion coating, coextrusion coating, and so forth.

The first bonding interlayer 112 may be an adhesive layer or an extruded polymer interlayer and the outer layer 110 and middle layer 120 can be bonded using conventional lamination techniques, such as adhesive lamination or extrusion lamination techniques. When the first bonding interlayer 112 is an adhesive layer, an adhesive is applied between the plies 110 and 120 and the plies 110 and 120 are bonded under suitable conditions. The adhesive may be applied to the surface of at least one of the layers 110 and 120 via any suitable coating method, e.g., spray coating, roll coating, blade coating, or similar technique. The adhesive may be any suitable adhesive, including single component adhesives, two component adhesives, solvent-based adhesives, solventless adhesives, water-based adhesives, acrylic adhesives, polyurethane adhesives, electron beam lamination adhesives, and UV lamination adhesives, as would be understood by persons skilled in the art.

When the first bonding interlayer 112 is an extrusion interlayer, the bonding interlayer 112 is extruded and brought onto a surface of one of the plies 110 and 120 as a melt curtain, e.g., just before the nip of lamination rollers, to laminate the plies 110 and 120. In embodiments wherein the first bonding interlayer 112 is an extruded polymer interlayer, the polymer may be any suitable polymer used for extrusion lamination, including low-density polyethylene (LDPE), linear low-density polyethylene (LLDPE), high-density polyethylene (HDPE), polypropylene (PP), ethylene-vinyl acetate (EVA), ethylene-methyl acrylate (EMA), ethylene-acrylic acid (EAA), ethylene-methacrylic acid (EMAA), ethylene-methyl methacrylate (EMMA), ionomers, and blends thereof, as would be understood by persons skilled in the art.

The optional second bonding interlayer 122 may be an adhesive layer or an extruded polymer interlayer and the middle layer 120 and sealant layer 130 can be bonded using conventional lamination techniques, such as adhesive lamination or extrusion lamination techniques. When the second bonding interlayer 122 is an adhesive layer, an adhesive is applied between the plies 120 and 130 and the plies 120 and 130 are bonded under suitable conditions. The adhesive may be applied to the surface of at least one of the layers 120 and 130 via any suitable coating method, e.g., spray coating, roll coating, blade coating, or similar technique. The adhesive may be any suitable adhesive, such as those described above by way of reference to the first bonding interlayer 112.

When the second bonding interlayer 122 is an extrusion interlayer, the bonding interlayer 122 is extruded and brought onto a surface of one of the plies 120 and 130 as a melt curtain, e.g., just before the nip of lamination rollers, to laminate the plies 120 and 130. In embodiments wherein the second bonding interlayer 122 is an extruded polymer interlayer, the polymer may be any suitable polymer used for extrusion lamination, such as those described above by way of reference to the first bonding interlayer 112.

In embodiments lacking the optional second bonding interlayer 122, sealant layer 130 is applied directly onto the inner surface of the outer layer 110 as an extrusion coating using a suitable extrusion coating process (in the case of a single layer sealant layer 130) or as a coextrusion coating using a suitable coextrusion coating process (in the case of a multilayer sealant layer 130).

In the illustrated embodiment, an optional ink layer 114 is disposed on the outer surface of the outer layer 110 and an optional outer coating layer 116 is disposed on the optional ink layer 114. Other configurations are also contemplated. In embodiments, one or both of the ink layer 114 and the outer coating layer 116 are omitted. In embodiments, the optional ink layer 114 is disposed on the inner surface of the outer layer 110, e.g., applied as reverse printing, or, on the outward facing surface of the middle layer 120, e.g., applied as forward printing, or, on the inward facing surface of the middle layer 120, e.g., applied as reverse printing, or, in cases where the sealant layer 130 an extrusion laminated layer or an adhesive laminated layer, on the outward facing surface of the sealant layer 130, e.g., applied as forward printing.

In embodiments wherein the ink layer 114 is absent or applied to a surface other than the outer surface of the outer layer 110, the optional coating layer 116 may be applied directly to the outer surface of the outer layer 110. The printing ink layer 114 can be applied via any conventional printing method as would be understood by persons skilled in the art, including without limitation, using a rotogravure printing apparatus, flexographic printing apparatus, offset printing apparatus, digital printing apparatus, ink jet printing apparatus, and the like. It will be recognized that the ink layer 114 may be applied either pre-lamination, inline, or as a separate post-lamination processing step, depending on the specific production requirements.

One of the outer layer 110 and the middle layer 120 comprises a machine direction oriented (MDO) polyolefin-based film and the other one of the outer layer 110 and the middle layer 120 comprises a biaxially oriented polar polymer-based film.

In embodiments, one of the outer layer 110 and the middle layer 120 comprises a machine direction oriented polyolefin-based film which has been stretched in the machine direction at a draw ratio from 3:1 to 10:1 and the other one of the outer layer 110 and the middle layer 120 comprises a biaxially oriented polar polymer-based film which has been stretched in the machine direction at a draw ratio from 3:1 to 10:1 and in the transverse direction at a draw ratio from 3:1 to 10:1.

In embodiments, one of the outer layer 110 and the middle layer 120 comprises a machine direction oriented polyolefin-based film configured to provide directional tear in the machine direction, wherein the tear resistance according to ASTM D1922 in the machine direction is less than 100 gf/mil, and the other one of the outer layer 110 and the middle layer 120 comprises a biaxially oriented polar polymer-based film having a maximum puncture force of 15 N or greater, as determined in accordance with ASTM F1306, such that the maximum puncture force of the overall film 100 is 20 N or greater, as determined in accordance with ASTM F1306.

In each of the various embodiments disclosed herein, the sealable inner layer, or any one or more polyolefin based sub layers in the case of a multilayer sealable inner layer, may optionally include a compatibilizer.

In certain embodiments, the optional compatibilizer comprises a polyolefin-based polymer or copolymer system which has one or more functional groups. The polyolefin-based polymer system preferably comprises polyethylene, polypropylene, polybutylene, or blends or copolymers thereof. Exemplary functional groups include carboxylic acid, ester, anhydride, aldehyde, ketone, isocyanate, epoxide, acrylate, alkene, alkyne, nitroso, imide, carbonate, nitrile, acid halide, such as an acid chloride, phosphoric acid derivatives, including esters, anhydrides, and salts of phosphoric acid, alkyl halide, sulfonyl halide, such as a sulfonyl chloride, aziridine, halogen, such as chlorine, bromine, and iodine, carbene, and sulfonic acid functional groups. Preferred functional groups include carboxylic acid, ester, anhydride, aldehyde, ketone, isocyanate, epoxide, alkene, alkyne, and nitroso functional groups.

In preferred embodiments, the optional compatibilizer is a multifunctionalized or multifunctional compatibilizer comprising a polyolefin-based polymer system which is functionalized or otherwise made functional with at least two functional groups. The presence of two or more different functional groups allows the compatibilizer to exhibit a broader range of compatibilization properties between different polar polymers and non-polar polyolefins. In embodiments, the multifunctionalized or multifunctional compatibilizer comprises (a) a polyolefin-based polymer system which is functionalized or otherwise made functional with two or more different functional groups on the same polymer chain or molecule; (b) a blend of two or more polyolefin-based polymers, each of which is functionalized or otherwise made functional with a different functional group; or (c) a combination thereof.

In certain embodiments, the optional compatibilizer is a low molecular weight compatibilizer, e.g., wherein the molecular weight is below about 50,000 g/mol. In certain embodiments, the optional compatibilizer is a medium molecular weight compatibilizer, e.g., wherein the molecular weight is in the range of from about 50,000 g/mol to about 200,000 g/mol. In certain embodiments, the optional compatibilizer is a high molecular weight compatibilizer, e.g., wherein the molecular weight is in the range of from about 200,000 g/mol to about 3,000,000 g/mol. In certain embodiments, the optional compatibilizer is an ultra-high molecular weight compatibilizer, e.g., wherein the molecular weight is above about 3,000,000 g/mol, e.g., up to about 10,000,000 g/mol or higher, depending on synthesis and processing constraints.

In embodiments, one of the outer layer 110 and the middle layer 120 comprises a machine direction oriented polyolefin-based film configured to provide directional tear in the machine direction, wherein the tear resistance according to ASTM D1922 in the machine direction is in the range of from about 10 gf/mil to about 100 gf/mil, and the other one of the outer layer 110 and the middle layer 120 comprises a biaxially oriented polar polymer-based film having a maximum puncture force in the range of from about 15 N to about 60 N, as determined in accordance with ASTM F1306, such that the maximum puncture force of the overall film 100 is in the range of from about 20 N to about 70 N, as determined in accordance with ASTM F1306.

In embodiments, one of the outer layer 110 and the middle layer 120 comprises a machine direction oriented polyolefin-based film configured to provide directional tear in the machine direction, wherein the tear resistance according to ASTM D1922 in the machine direction is in the range of from about 10 gf/mil to about 100 gf/mil, e.g., 10 gf/mil, 11 gf/mil, 12 gf/mil, 13 gf/mil, 14 gf/mil, 15 gf/mil, 16 gf/mil, 17 gf/mil, 18 gf/mil, 19 gf/mil, 20 gf/mil, 21 gf/mil, 22 gf/mil, 23 gf/mil, 24 gf/mil, 25 gf/mil, 26 gf/mil, 27 gf/mil, 28 gf/mil, 29 gf/mil, 30 gf/mil, 31 gf/mil, 32 gf/mil, 33 gf/mil, 34 gf/mil, 35 gf/mil, 36 gf/mil, 37 gf/mil, 38 gf/mil, 39 gf/mil, 40 gf/mil, 41 gf/mil, 42 gf/mil, 43 gf/mil, 44 gf/mil, 45 gf/mil, 46 gf/mil, 47 gf/mil, 48 gf/mil, 49 gf/mil, 50 gf/mil, 51 gf/mil, 52 gf/mil, 53 gf/mil, 54 gf/mil, 55 gf/mil, 56 gf/mil, 57 gf/mil, 58 gf/mil, 59 gf/mil, 60 gf/mil, 61 gf/mil, 62 gf/mil, 63 gf/mil, 64 gf/mil, 65 gf/mil, 66 gf/mil, 67 gf/mil, 68 gf/mil, 69 gf/mil, 70 gf/mil, 71 gf/mil, 72 gf/mil, 73 gf/mil, 74 gf/mil, 75 gf/mil, 76 gf/mil, 77 gf/mil, 78 gf/mil, 79 gf/mil, 80 gf/mil, 81 gf/mil, 82 gf/mil, 83 gf/mil, 84 gf/mil, 85 gf/mil, 86 gf/mil, 87 gf/mil, 88 gf/mil, 89 gf/mil, 90 gf/mil, 91 gf/mil, 92 gf/mil, 93 gf/mil, 94 gf/mil, 95 gf/mil, 96 gf/mil, 97 gf/mil, 98 gf/mil, 99 gf/mil, 100 gf/mil, or any subrange thereof.

In embodiments, the other one of the outer layer 110 and the middle layer 120 comprises a biaxially oriented polar polymer-based film having a maximum puncture force in the range of from about 15 N to about 60 N, as determined in accordance with ASTM F1306, e.g., 20 N, 21 N, 22 N, 23 N, 24 N, 25 N, 26 N, 27 N, 28 N, 29 N, 30 N, 31 N, 32 N, 33 N, 34 N, 35 N, 36 N, 37 N, 38 N, 39 N, 40 N, 41 N, 42 N, 43 N, 44 N, 45 N, 46 N, 47 N, 48 N, 49 N, 50 N, 51 N, 52 N, 53 N, 54 N, 55 N, 56 N, 57 N, 58 N, 59 N, 60 N, and any subrange thereof.

In embodiments, the maximum puncture force of the overall film 100 is in the range of from about 20 N to about 70 N, as determined in accordance with ASTM F1306, e.g., 20 N, 21 N, 22 N, 23 N, 24 N, 25 N, 26 N, 27 N, 28 N, 29 N, 30 N, 31 N, 32 N, 33 N, 34 N, 35 N, 36 N, 37 N, 38 N, 39 N, 40 N, 41 N, 42 N, 43 N, 44 N, 45 N, 46 N, 47 N, 48 N, 49 N, 50 N, 51 N, 52 N, 53 N, 54 N, 55 N, 56 N, 57 N, 58 N, 59 N, 60 N, 61 N, 62 N, 63 N, 64 N, 65 N, 66 N, 67 N, 68 N, 69 N, 70 N, and any subrange thereof.

The outer layer 110 comprises a polar polymer film and, in preferred embodiments, an oriented polar polymer film. In certain embodiments, the outer layer 110 comprises a blown or cast polar polymer film, with or without any additional stretching or orientation of the film after the initial blown or cast film extrusion process. The outer layer 110 may be a monolayer or multilayer structure. In embodiments, the outer layer 110 is formed of at least one polar polymer selected from polyamides and polyesters. In embodiments, the outer layer 110 comprises a polyamide. Exemplary polyamides include, but are not limited to, nylons such as cast nylon, nylon 6, nylon 66, nylon 6/66, nylon 12, and blends and copolymers thereof. In embodiments, the outer layer 110 is biaxially oriented nylon (BON) or monoaxially oriented nylon. In embodiments, the outer layer 110 is formed of a polyester, including without limitation oriented polyethylene terephthalate (OPET), and biaxially oriented polyethylene terephthalate (BOPET).

In embodiments, the outer layer 110 or middle layer 120 that is a biaxially oriented polar polymer-based film is formed of a biaxially oriented polyester, such as biaxially oriented polyethylene terephthalate (BOPET), biaxially oriented polybutylene terephthalate (BOPBT), or biaxially oriented films formed from copolymers or blends thereof. In embodiments, the outer layer 110 or middle layer 120 that is a biaxially oriented polar polymer-based film is formed of a biaxially oriented polyamide such as biaxially oriented nylon (BON), which may be formed of nylon 6, nylon 66, nylon 6/66, nylon 12, and blends and copolymers thereof.

The sealant layer 130 is a polyolefin-based sealant layer and may be a monolayer or multilayer structure and optionally includes a moisture vapor barrier layer, an oxygen barrier layer, or both. In preferred embodiments, the innermost surface (i.e., product-facing surface) of the sealant layer 130 comprises a heat-sealable polymer configured to form a hermetic seal with itself or similar surfaces under predetermined sealing conditions, i.e., sealing temperature, sealing pressure, and dwell time. In embodiments, the sealant layer comprises polyethylene, polypropylene, or blends or copolymers thereof. Examples of polyolefin-based polymers include polyethylene (PE), polypropylene (PP), polyolefin blends, or polyolefin copolymers. In embodiments, sealant layer 130 comprises low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymers (COC), cast polypropylene (CPP), ethylene-propylene copolymer (EPC), and other polyolefin materials, including post-consumer recycled (PCR) polyolefins, as well as blends, coextrusions, and laminations of any of the foregoing, provided that at least the exterior most layer is a heat sealable polyolefin layer.

In embodiments, the film structure 100 comprises at least 70% polyethylene by weight. In embodiments, the film structure 100 comprises at least 75% polyethylene by weight. In embodiments, the film structure 100 comprises at least 80% polyethylene by weight. In embodiments, the film structure 100 comprises at least 85% polyethylene by weight. In embodiments, the film structure 100 comprises at least 90% polyethylene by weight. In embodiments, the film structure 100 comprises at least 95% polyethylene by weight.

In embodiments, the nonpolar polymer component(s) of the polyolefin-based sealant layer 120 may be a coextruded film with a barrier layer and optional tie resin layers as would be understood by persons skilled in the art. In embodiments, the barrier layer is selected from ethylene vinyl alcohol copolymer (EVOH), polyamide (PA), such as nylon 6, nylon 66, nylon 6/66, polyvinyl alcohol (PVOH), and the like.

In embodiments, the coating layer 116 is selected from the group consisting of an energy cured coating and a two-part coating. The term “energy-cured coating” refers to a coating of one or more reactive monomer, oligomer, or polymer compositions, which is irreversibly converted into a solid polymer coating via reactive groups in the reactive monomer, oligomer, or polymer compositions upon the application of energy from a suitable energy source, such as irradiation with electron beams or irradiation with electromagnetic radiation, such as ultraviolet (UV) light or thermal radiation (heat).

In embodiments, the coating layer 116 is a cured polyacrylate composition formed from by curing a reactive polymer composition comprising one or more monomers, oligomers, polymers, acrylates, polyacrylates, and/or polyacrylate copolymers. In certain embodiments, the coating layer 116 is an electron beam cured composition that includes, but is not limited to, ethoxylated trimethylolpropane triacrylates, acrylated resins and acrylate ester resins, polyol acrylates, trimethylolpropane triacrylates, polydimethylsiloxane acrylates, and maleic anhydrides. Other energy-cured coating compositions may include monomers and oligomers that contain vinyl and allyl compounds, as well as monomers and oligomers that are induced into UV polymerization and curing through the mediation of photoinitiators and exposure to UV light and coatings that provide enhanced oxygen and moisture barrier properties.

In certain embodiments, the energy-cured coating has a coating thickness in the range of from about 0.78 micron (0.03 mil) to about 8 microns (0.31 mil), preferably from about 2.3 microns (0.091 mil) to about 4.7 micron (0.19 mil). In certain embodiments the energy-cured coating has a density in the range of from about 0.85 g/cc to about 1.25 g/cc, preferably from about 1.02 to about 1.06 g/cc, and most preferably about 1.04 g/cc. In certain embodiments, the energy-cured coating has a coating weight in the range of from about 0.5 lb/ream (0.81 g/m²) to about 5.0 lb/ream (8.14 g/m²), preferably of from about 1.5 lb/ream (2.44 g/m²) to about 3.0 lb/ream (4.88 g/m²).

In embodiment the outer layer 116 comprises a two-part coating formed through the polymerization of two starting components, namely, a cross-linkable binder component and a cross-linking agent component, wherein the cross-linkable binder component and the cross-linking agent component are combined to form a coating composition prior to application to the film construction and wherein the reactive constituents thereof combine through a curing process.

In embodiments, the outer layer 116 is a two-part coating formed from a coating composition comprising a cross-linkable binder and cross-linking agent, wherein the coating composition is curable at room temperature. In embodiments, the coating composition has a full curing time in the range of from about 1-15 days. The cross-linking agent chemically reacts with the cross-linkable agent and, since reactions begin as soon as the cross-linkable binder and the cross-linking agent are mixed, the two-part coating is preferably mixed in batches and brought to the press.

The cross-linking agent comprises an isocyanate compound having at least one isocyanate group (R—N═C═O), such as 1,6-hexane diisocyanate (HDI), toluene diisocyanate (TDI), hexamethylene-di-isocyanate. The cross-linkable binder comprises a polymer selected from nitrocelluloses, polyesters, and polyurethanes. In embodiments, the polyurethane is a polyurethane having hydroxyl functional groups. In embodiments, the ratio of the cross-linkable binder to the cross-linking agent in the coating mixture is in the range of 100:10 to 100:40, by weight.

In embodiments, the two-part coating is applied using a printer at high speed, e.g., 100-500 m/min. After applying the coating, the coated film is passed through oven/dryer to remove the solvent and the wound up on a take up roll with minimum tension on the roll to avoid passing volatile organic liquids from the coating layer to the other side of the roll. The roll is then set aside to complete the curing and reaction, e.g., for 1-15 days depending on the cure time of the two-part coating composition.

In embodiments, the coating weight of mixed coating is in the range of 0.75 pounds per ream (1.22 grams per square meter) to 3 pounds per ream (4.88 grams per square meter) dry weight and more preferably in the range of 1.0 pounds per ream (1.63 grams per square meter) to 1.5 pounds per ream (2.44 grams per square meter) dry weight. Solvents for the cross-linkable binder and cross-linking agent include alcohols and esters, including without limitation, isopropanol, ethyl acetate, and n-propyl acetate. The two-part coating is commercially available through different industrial coating suppliers such as Sun Chemical Corporation of Parsippany, NJ, J.M. Huber Corporation of Edison, NJ, Siegwerk Druckfarben AG & Co. KGaA of Siegburg, Germany, DAW SE of Ober-Ramstadt, Germany, and others. The two-part coating provides a similar melting resistance to the outer surface of the film structures as the energy-cured coatings herein. It will be recognized that outer coating layer 116 may be applied either pre-lamination, inline, or as a separate post-lamination processing step, depending on the specific production requirements.

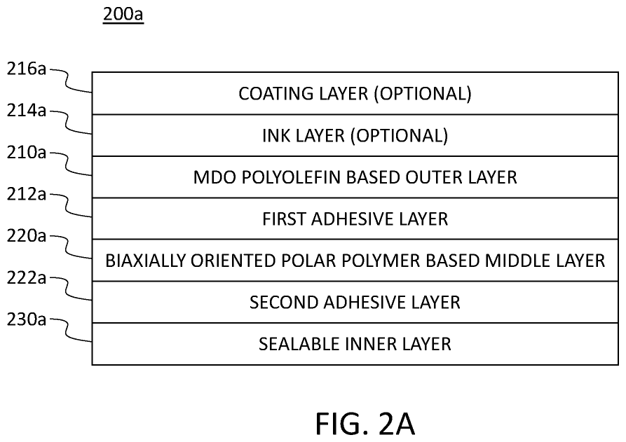

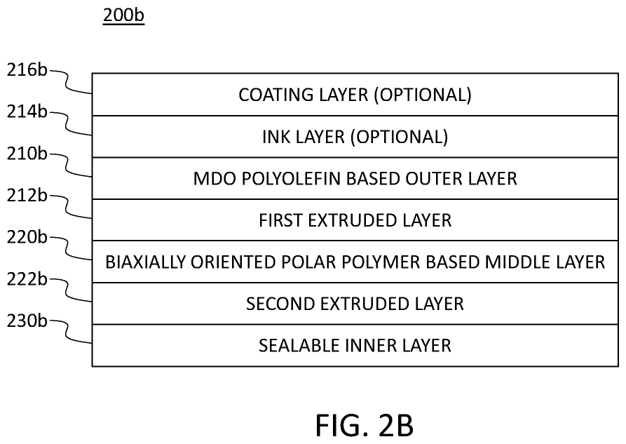

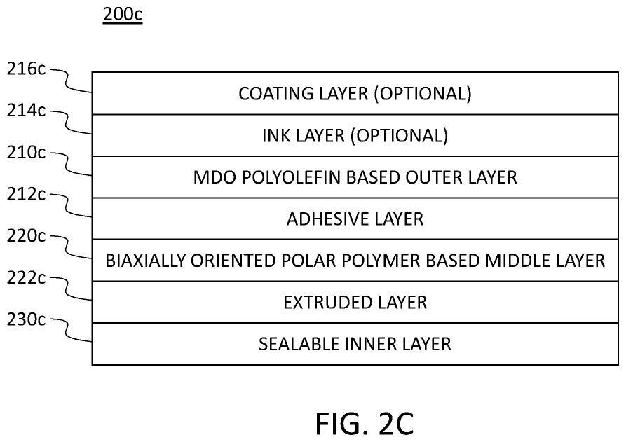

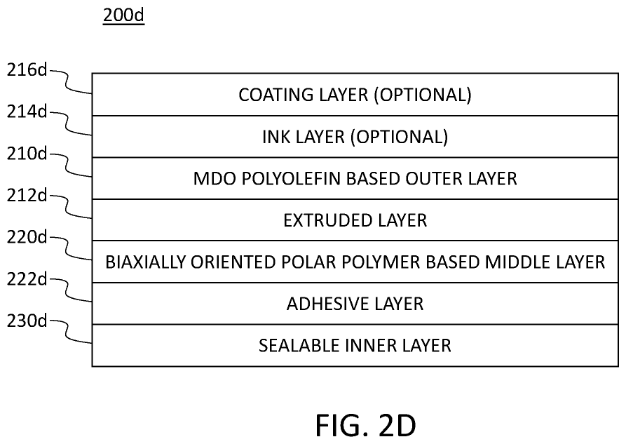

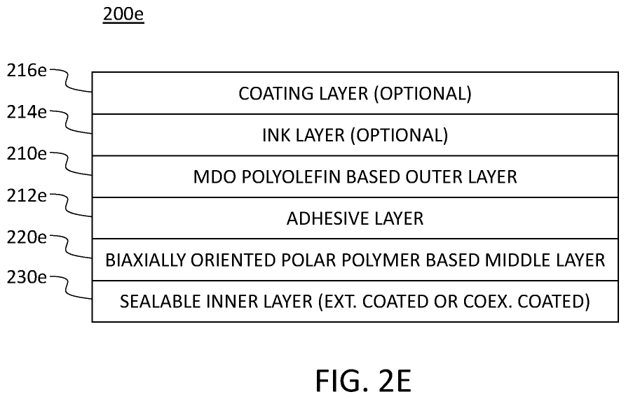

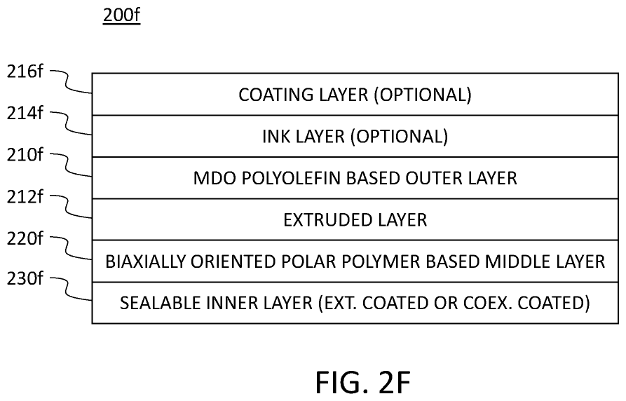

Referring now to FIG. 2A there is illustrated a first embodiment film structure 200a, comprising an outer layer 210a formed of a machine direction oriented polyolefin-based polymer adhesively laminated to a middle layer 220a formed of a biaxially oriented polar polymer-based polymer via a first adhesive layer 212a. A sealant layer 230a is adhesively laminated to the middle layer 220a via a second adhesive layer 222a. The film structure 200a optionally includes an ink layer 214a disposed on the outer layer 210a or elsewhere, as described above, and an optional coating layer 216a. The composition of each layer 210a, 212a, 214a, 216a, 220a, 222a, and 230a is as previously described with reference to the corresponding layer in FIG. 1.

Referring now to FIG. 2B there is illustrated a second embodiment film structure 200b, comprising an outer layer 210b formed of a machine direction oriented polyolefin-based polymer extrusion laminated to a middle layer 220b formed of a biaxially oriented polar polymer-based polymer via a first extruded interlayer 212b. A sealant layer 230b is extrusion laminated to the middle layer 220b via a second extruded interlayer 222b. The film structure 200b optionally includes an ink layer 214b disposed on the outer layer 210b or elsewhere, as described above, and an optional coating layer 216b. The composition of each layer 210b, 212b, 214b, 216b, 220b, 222b, and 230b is as previously described with reference to FIG. 1.

Referring now to FIG. 2C there is illustrated a third embodiment film structure 200c, comprising an outer layer 210c formed of a machine direction oriented polyolefin-based polymer adhesively laminated to a middle layer 220c formed of a biaxially oriented polar polymer-based polymer via an adhesive layer 212c. A sealant layer 230c is extrusion laminated to the middle layer 220c via an extruded interlayer 222c. The film structure 200c optionally includes an ink layer 214c disposed on the outer layer 210c or elsewhere, as described above, and an optional coating layer 216c. The composition of each layer 210c, 212c, 214c, 216c, 220c, 222c, and 230c is as previously described with reference to FIG. 1.

Referring now to FIG. 2D there is illustrated a fourth embodiment film structure 200d, comprising an outer layer 210d formed of a machine direction oriented polyolefin-based polymer extrusion laminated to a middle layer 220d formed of a biaxially oriented polar polymer-based polymer via an extrusion layer 212d. A sealant layer 230d is adhesively laminated to the middle layer 220d via an adhesive layer 222d. The film structure 200d optionally includes an ink layer 214d disposed on the outer layer 210d or elsewhere, as described above, and an optional coating layer 216d. The composition of each layer 210d, 212d, 214d, 216d, 220d, 222d, and 230d is as previously described with reference to FIG. 1.

Referring now to FIG. 2E there is illustrated a fifth embodiment film structure 200e, comprising an outer layer 210e formed of a machine direction oriented polyolefin-based polymer adhesively laminated to a middle layer 220e formed of a biaxially oriented polar polymer-based polymer via an adhesive layer 212e. A sealant layer 230e is attached to the inner surface of the middle layer 220e as an extrusion coating layer (in the case of a monolayer sealant layer 230e or as coextrusion coating layers (in the case of a multilayer sealant layer 230e. The film structure 200e optionally includes an ink layer 214e disposed on the outer layer 210c or elsewhere, as described above, and an optional coating layer 216e. The composition of each layer 210e, 212e, 214e, 216e, 220e, and 230e is as previously described with reference to FIG. 1.

Referring now to FIG. 2F there is illustrated a sixth embodiment film structure 200e, comprising an outer layer 210f formed of a machine direction oriented polyolefin-based polymer extrusion laminated to a middle layer 220f formed of a biaxially oriented polar polymer-based polymer via an extrusion interlayer 212f. A sealant layer 230f is attached to the inner surface of the middle layer 220f as an extrusion coating layer (in the case of a monolayer sealant layer 230f or as coextrusion coating layers (in the case of a multilayer sealant layer 230f. The film structure 200f optionally includes an ink layer 214f disposed on the outer layer 210c or elsewhere, as described above, and an optional coating layer 216f. The composition of each layer 210f, 212f, 214f, 216f, 220f, and 230f is as previously described with reference to FIG. 1.

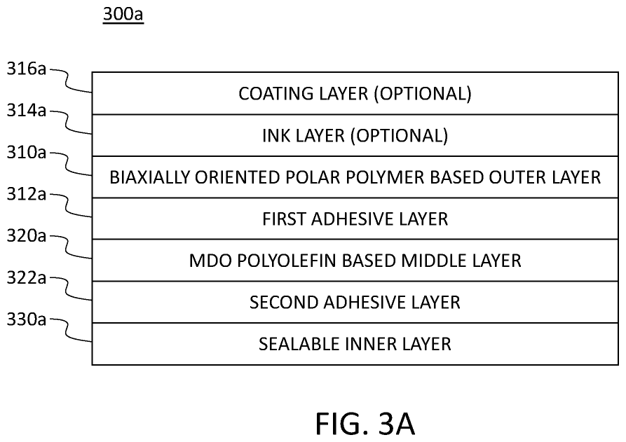

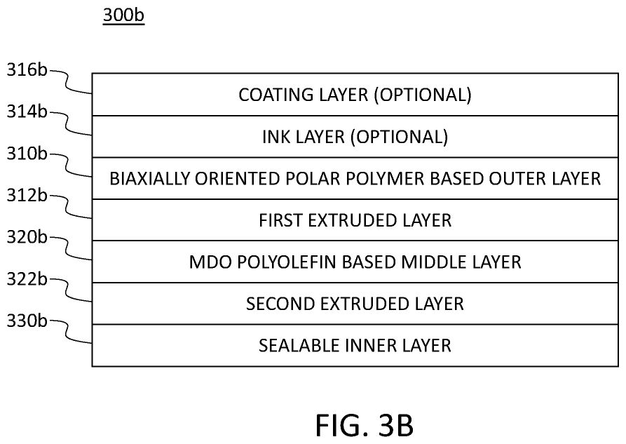

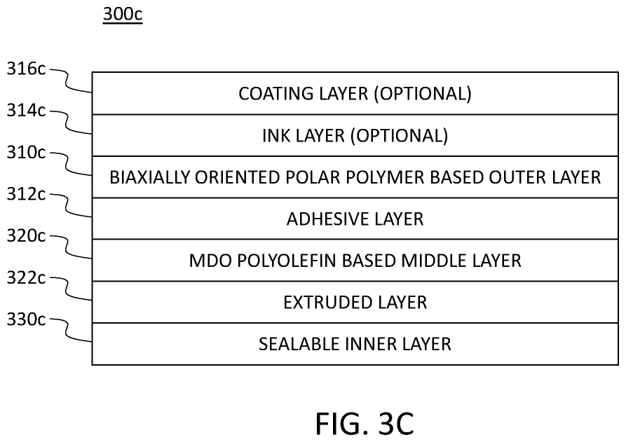

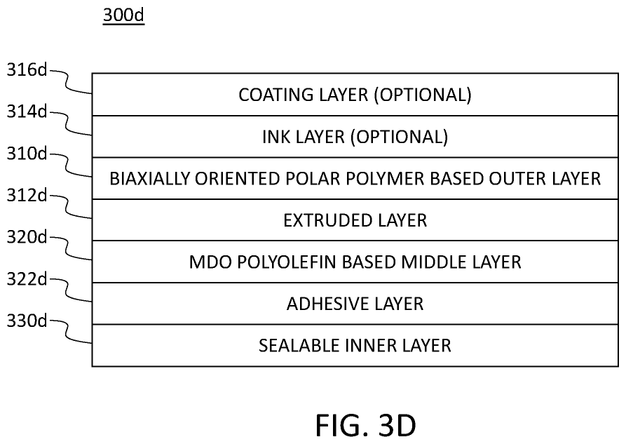

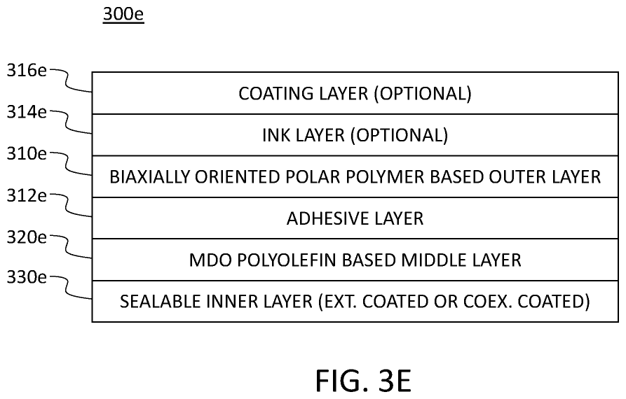

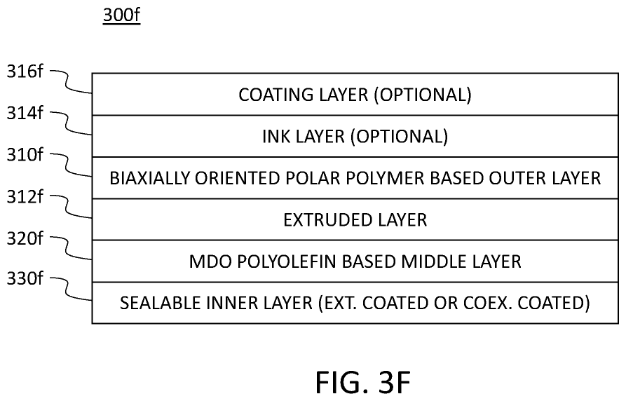

Referring now to FIG. 3A there is illustrated a first embodiment film structure 300a, comprising an outer layer 310a formed of a biaxially oriented polar polymer-based polymer adhesively laminated to a middle layer 320a formed of a machine direction oriented polyolefin-based polymer via a first adhesive layer 312a. A sealant layer 330a is adhesively laminated to the middle layer 320a via a second adhesive layer 322a. The film structure 300a optionally includes an ink layer 314a disposed on the outer layer 310a or elsewhere, as described above, and an optional coating layer 316a. The composition of each layer 310a, 312a, 314a, 316a, 320a, 322a, and 330a is as previously described with reference to FIG. 1.

Referring now to FIG. 3B there is illustrated a second embodiment film structure 300b, comprising an outer layer 310b formed of a biaxially oriented polar polymer-based polymer extrusion laminated to a middle layer 320b formed of a machine direction oriented polyolefin-based polymer via a first extruded interlayer 312b. A sealant layer 330b is extrusion laminated to the middle layer 320b via a second extruded interlayer 322b. The film structure 300b optionally includes an ink layer 314b disposed on the outer layer 310b or elsewhere, as described above, and an optional coating layer 316b. The composition of each layer 310b, 312b, 314b, 316b, 320b, 322b, and 330b is as previously described with reference to FIG. 1.

Referring now to FIG. 3C there is illustrated a third embodiment film structure 300c, comprising an outer layer 310c formed of a biaxially oriented polar polymer-based polymer adhesively laminated to a middle layer 320c formed of a machine direction oriented polyolefin-based polymer via an adhesive layer 312c. A sealant layer 330c is extrusion laminated to the middle layer 320c via an extruded interlayer 322c. The film structure 300c optionally includes an ink layer 314c disposed on the outer layer 310c or elsewhere, as described above, and an optional coating layer 316c. The composition of each layer 310c, 312c, 314c, 316c, 320c, 322c, and 330c is as previously described with reference to FIG. 1.

Referring now to FIG. 3D there is illustrated a fourth embodiment film structure 300d, comprising an outer layer 310d formed of a biaxially oriented polar polymer-based polymer extrusion laminated to a middle layer 320d formed of a machine direction oriented polyolefin-based polymer via an extrusion layer 312d. A sealant layer 330d is adhesively laminated to the middle layer 320d via an adhesive layer 322d. The film structure 300d optionally includes an ink layer 314d disposed on the outer layer 310d or elsewhere, as described above, and an optional coating layer 316d. The composition of each layer 310d, 312d, 314d, 316d, 320d, 322d, and 330d is as previously described with reference to FIG. 1.

Referring now to FIG. 3E there is illustrated a fifth embodiment film structure 300e, comprising an outer layer 310e formed of a biaxially oriented polar polymer-based polymer adhesively laminated to a middle layer 320e formed of a machine direction oriented polyolefin-based polymer via an adhesive layer 312e. A sealant layer 330e is attached to the inner surface of the middle layer 320e as an extrusion coating layer (in the case of a monolayer sealant layer 330e or as coextrusion coating layers (in the case of a multilayer sealant layer 330e. The film structure 300e optionally includes an ink layer 314e disposed on the outer layer 310c or elsewhere, as described above, and an optional coating layer 316e. The composition of each layer 310e, 312e, 314e, 316e, 320e, and 330e is as previously described with reference to FIG. 1.

Referring now to FIG. 3F there is illustrated a sixth embodiment film structure 300e, comprising an outer layer 310f formed of a biaxially oriented polar polymer-based polymer extrusion laminated to a middle layer 320f formed of a machine direction oriented polyolefin-based polymer via an extrusion interlayer 312f. A sealant layer 330f is attached to the inner surface of the middle layer 320f as an extrusion coating layer (in the case of a monolayer sealant layer 330f or as coextrusion coating layers (in the case of a multilayer sealant layer 330f. The film structure 300f optionally includes an ink layer 314f disposed on the outer layer 310c or elsewhere, as described above, and an optional coating layer 316f. The composition of each layer 310f, 312f, 314f, 316f, 320f, and 330f is as previously described with reference to FIG. 1.

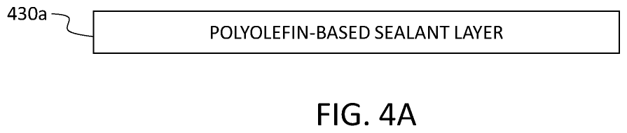

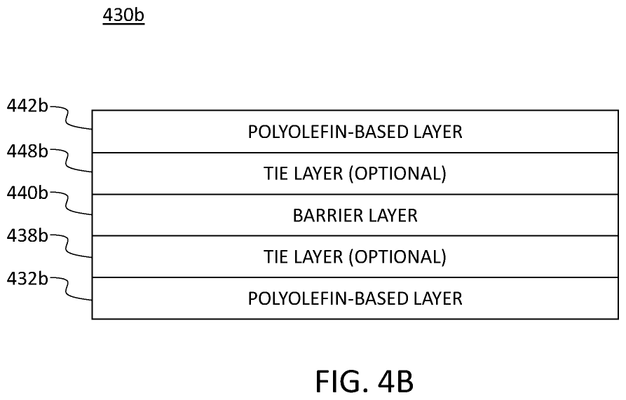

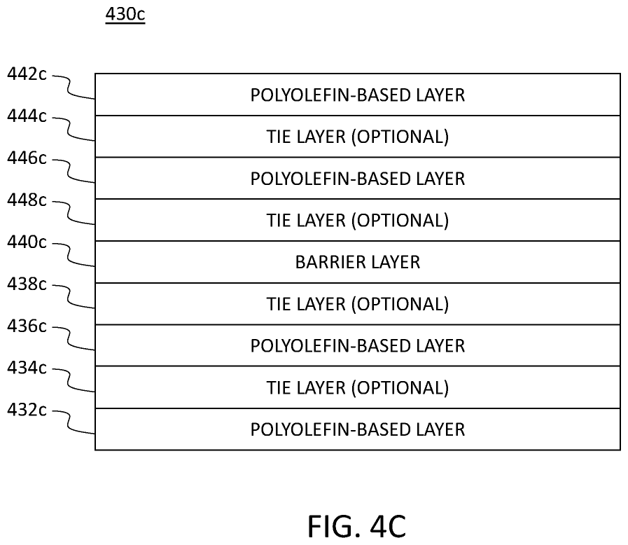

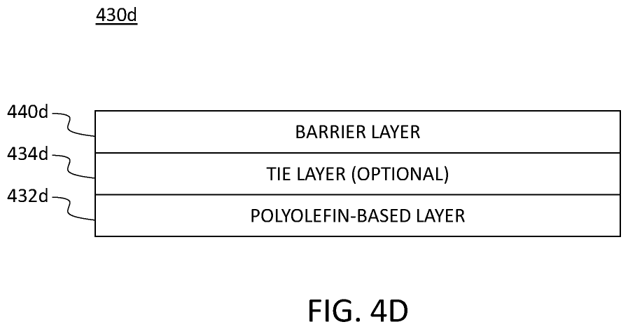

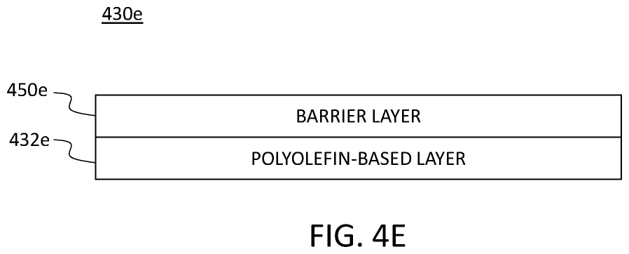

Referring now to FIG. 4A, there is shown a film layer 430a, which illustrates an exemplary nonbarrier sealant layer which may embody the inner sealant layer 130 of FIG. 1. The film layer 430a may be a monolayer or a multilayer sealant layer wherein each layer is formed of a polyolefin-based polymer material, e.g., polyethylene, polypropylene, and blends and copolymers thereof, as described above. In the case of a multilayer film layer 430a, the layer 430a comprises two or more sublayers, wherein each sublayer may be the same or different in composition.

The film layer 430a may be separately formed and laminated to the middle layer 120 via an adhesive lamination or extrusion lamination process, or, alternatively, applied directly to the middle layer 120 as an extrusion coating layer (in the case of a monolayer sealant layer 430a) or as coextrusion coating layers (in the case of a multilayer sealant layer 430a) via an extrusion coating or coextrusion coating process.

Referring now to FIG. 4B, there is shown a polyolefin-based sealant layer 430b which illustrates a first exemplary barrier film layer operable to embody the inner sealant layer 130 of FIG. 1. The film layer 430b comprises a core barrier layer 440b coextruded between two polyolefin-based sublayers 432b and 442b, each comprising a polyolefin-based polymer, and which may be the same or different, provided that at least the innermost sublayer 432b is formed of a heat sealable polyolefin-based polymer material. In embodiments, the barrier layer 440b comprises one or more polymers selected from PVOH, EVOH, and polyamide (e.g., nylon 6, nylon 66, nylon 6/66, nylon 12, and blends and copolymers thereof). In embodiments, the barrier layer 440b is a monolayer film. In embodiments, the barrier layer 440b is a multilayer film which optionally includes tie layers between adjacent layers within the barrier layer 440b.

Optional tie layers 438b, 448b comprising a tie resin may be provided between the adjacent layers 432b and 440b and/or between the adjacent layers 442b and 440b to facilitate adhesion between the layers. Such tie resins may include any suitable tie resin as is known to persons skilled in the for art, including for example:
(a) polyolefins grafted with carboxylic acids or anhydride derivatives, preferably polyolefins grafted with lower carboxylic acids or lower anhydride derivatives, including but not limited to polyethylene (PE) grafted with acrylic acid (AA) (PE-g-AA), polyethylene (PE) grafted with maleic anhydride (MA) (PE-g-MA) polyethylene (PE) grafted with methacrylic acid (MAA) (PE-g-MAA), polypropylene (PP) grafted with acrylic acid (AA) (PP-g-AA), polypropylene (PP) grafted with maleic anhydride (MA) (PP-g-MA), and polypropylene (PP) grafted with methacrylic acid (MAA) (PP-g-MAA);
(b) copolymers of alkylenes, preferably lower alkylenes, and unsaturated carboxylic acids (preferably lower unsaturated carboxylic acids), including but not limited to ethylene-acrylic acid (EAA) copolymer, ethylene-methacrylic acid (EMAA) copolymer, propylene-acrylic acid copolymer, propylene-methacrylic acid copolymer, butylene-acrylic acid copolymer, butylene-methacrylic acid copolymer;
(c) copolymers of alkylenes, preferably lower alkylenes, and alkyl esters derived from unsaturated carboxylic acids (preferably lower alkyl esters derived from lower unsaturated carboxylic acids), including without limitation, ethylene-methyl acrylate copolymer (EMA), ethylene-ethyl acrylate copolymer (EEA), ethylene-propyl acrylate copolymer, ethylene-butyl acrylate copolymer (EBA), propylene-methyl acrylate copolymer, propylene-ethyl acrylate copolymer, propylene-propyl acrylate copolymer, propylene-butyl acrylate copolymer, ethylene-methyl methacrylate copolymer (EMMA), ethylene-ethyl methacrylate copolymer (EEMA), ethylene-propyl methacrylate copolymer, ethylene-butyl methacrylate copolymer (EBAM), propylene-methyl methacrylate copolymer, propylene-ethyl methacrylate copolymer, propylene-propyl methacrylate copolymer, propylene-butyl methacrylate copolymer; or
(d) terpolymers of alkylenes, unsaturated carboxylic acids or alkyl esters derived therefrom, and anhydrides, more preferably terpolymers of lower alkylenes, lower unsaturated carboxylic acids or lower alkyl esters derived therefrom, and lower anhydrides, including but not limited to ethylene-butyl acrylate-maleic anhydride terpolymer, ethylene-acrylic acid-maleic anhydride terpolymer, ethylene-methacrylic acid-maleic anhydride terpolymer, ethylene-methyl acrylate-maleic anhydride terpolymer, ethylene-ethyl acrylate-maleic anhydride terpolymer, ethylene-propyl acrylate-maleic anhydride terpolymer, ethylene-methyl methacrylate-maleic anhydride terpolymer, ethylene-ethyl methacrylate-maleic anhydride terpolymer, ethylene-propyl methacrylate-maleic anhydride terpolymer, ethylene-butyl methacrylate-maleic anhydride terpolymer, propylene-acrylic acid-maleic anhydride terpolymer, propylene-methacrylic acid-maleic anhydride terpolymer, propylene-methyl acrylate-maleic anhydride terpolymer, propylene-ethyl acrylate-maleic anhydride terpolymer, propylene-propyl acrylate-maleic anhydride terpolymer, propylene-butyl acrylate-maleic anhydride terpolymer, propylene-methyl methacrylate-maleic anhydride terpolymer, propylene-ethyl methacrylate-maleic anhydride terpolymer, propylene-propyl methacrylate-maleic anhydride terpolymer, propylene-butyl methacrylate-maleic anhydride terpolymer;
(f) copolymers of alkylenes, preferably lower alkylene, and vinyl acetate, including but not limited to ethylene vinyl acetate (EVA), vinyl acetate ethylene (VAE), propylene vinyl acetate (PVA), and vinyl acetate propylene (VAP); or
(f) any combinations of the foregoing.

In certain embodiments, the coextruded film layer 430b has the following structure, wherein optional tie layers (“tie”) may be provided to promote adhesion between adjacent layers:

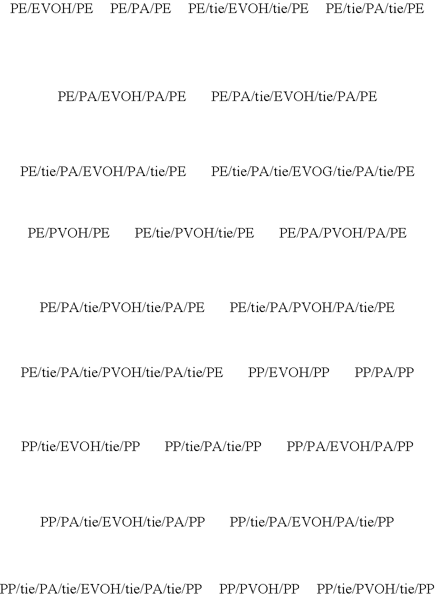

Exemplary polyolefin-based polymers include polyethylene (PE) polymers, polypropylene (PP) polymers, and polyolefin copolymers (including ethylene-propylene copolymers), as described above. Exemplary barriers include ethylene vinyl alcohol copolymer (EVOH) polyvinyl alcohol (PVOH), and/or polyamide (PA). Exemplary polyamides include nylon, such as nylon 6, nylon 66, nylon 6/66, nylon 12, and combinations thereof. Exemplary structures for the coextruded film layer 430b include:

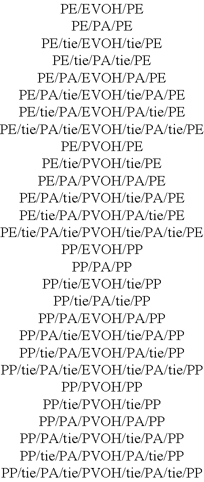

In certain embodiments, the film layer 430b is separately formed as a coextruded film and laminated to the middle layer 120 via an adhesive lamination or extrusion process. In other embodiments, film layer 430b is applied directly to the middle layer 120 via coextrusion coating process.

Referring now to FIG. 4C, there is shown a film layer 430c, which illustrates an exemplary barrier film layer operable to embody the inner sealant layer 130 of FIG. 1. The film layer 430c comprises a barrier layer 440c coextruded between dual polyolefin-based sealant layers 432c and 436c on the inward facing side of the barrier layer 440c, each of which may be the same or different and each of which comprises a polyolefin-based polymer as described above, and dual polyolefin-based sealant layers 442c and 446c on the outward facing side of the barrier layer 440c, each of which may be the same or different and each of which comprises a polyolefin-based polymer as described above. In embodiments, the barrier layer 440c comprises a polymer selected from PVOH, EVOH, (e.g., nylon 6, nylon 66, nylon 6/66, nylon 12, and blends and copolymers thereof).

Optional tie layers 434c and 444c comprising a tie resin may be provided between the adjacent layer pairs 432c, 436c and 442c, 446c, respectively, to facilitate adhesion between the layers. Optional tie layers 438c and 448c comprising a tie resin may be provided between the adjacent layer pairs 436c, 440c and 446c, 440c, respectively, to facilitate adhesion between the layers. Such tie resins may include any suitable tie resin as is known to persons skilled in the for art, including for example, one or more tie resins as described above by way of reference to FIG. 4B.

In certain embodiments, the coextruded a film layer 430c has the following structure, wherein optional tie layers (“tie”) may be provided to promote adhesion between adjacent layers:

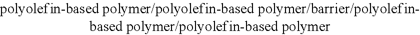

Exemplary polyolefin-based polymers include polyethylene (PE) polymers, polypropylene (PP) polymers, and polyolefin copolymers (including ethylene-propylene copolymers), as described above. Exemplary barriers include ethylene vinyl alcohol copolymer (EVOH) polyvinyl alcohol (PVOH), and/or polyamide (PA). Exemplary polyamides include nylon, such as nylon 6, nylon 66, nylon 6/66, nylon 12, and combinations thereof. Exemplary structures for the coextruded film layer 430c include:

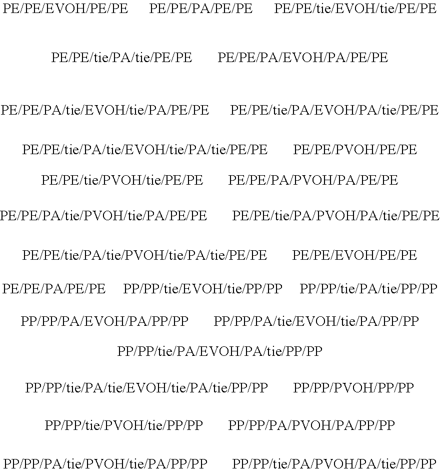

In certain embodiments, the film layer 430c is separately formed as a coextruded film and laminated to the middle layer 120 via an adhesive lamination or extrusion lamination process. In other embodiments, film layer 430c is applied directly to the middle layer 120 via coextrusion coating process.

Referring now to FIG. 4D, there is shown a coextrusion coating film layer 430d, which illustrates an exemplary barrier film layer operable to embody the inner sealant layer 130 of FIG. 1. The film layer 430d comprises a barrier layer 440d coextruded with a polyolefin-based sealant layer 432d, wherein the barrier layer 430d is applied directly onto the inward facing side of the middle layer 120 via a coextrusion coating process. The polyolefin-based sealant layer 432d may be a monolayer or multilayer structure. In embodiments, the barrier layer 440d comprises a polymer selected from PVOH, EVOH, (e.g., nylon 6, nylon 66, nylon 6/66, nylon 12, and blends and copolymers thereof).

An optional tie layer 434c comprising a tie resin may be provided between the barrier layer 440d and the polyolefin-based sealant layer 432d to facilitate adhesion between the layers. Such tie resin may include any suitable tie resin as is known to persons skilled in the for art, including for example, one or more tie resins as described above by way of reference to FIG. 4B.

Referring now to FIG. 4E, there is shown a film layer 430e, which illustrates an exemplary coating or deposition barrier layer which may embody the inner layer 130 of FIG. 1. The film layer 430e comprises a polyolefin-based sealant layer 432e as described above, which may be a monolayer or multilayer film and an inorganic gas (e.g., oxygen), and/or moisture barrier layer 450e deposited thereon.

The inorganic barrier layer 450e is deposited on the outward facing surface of the polyolefin-based sealant layer 432e. In embodiments, the barrier layer 450e is metal oxide coating layer, such as aluminum oxide (AlOx), silicon oxide (SiOx), or a mixture thereof. The metal oxide coating layer may be deposited using physical or chemical deposition techniques or a solution coating technique. In embodiments, the barrier layer 450e is metallization coating layer, such as an aluminum metallization layer. The metallization coating layer may be deposited using physical or chemical deposition techniques. Examples of the film layer 430e include:

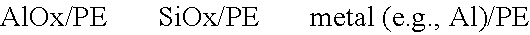

The layer 430e is laminated to the middle layer 120 with the barrier layer 450e facing toward the inward facing surface of the middle layer 120 via an adhesive lamination or extrusion lamination process. Optionally, a protective topcoat may be applied over the polymeric barrier layer 450e to enhance resistance to abrasion or other physical damage.

In further embodiments, the barrier layer 450e comprises a solution-coated polymeric barrier layer. In such embodiments, a polymeric material, such as ethylene vinyl alcohol (EVOH) or polyvinyl alcohol (PVOH), is applied to a surface of the film layer 432e. In embodiments, the polymeric barrier layer 450e is formed by solution coating by any suitable coating technique, such as gravure coating, slot die coating, spray coating, or the like. For example, a solution comprising the barrier polymer dissolved or dispersed in a suitable aqueous or nonaqueous solvent, such as water, alcohol, or a mixture thereof. After application, the coated layer is dried to form the polymeric barrier layer 450e. Optionally, a protective topcoat may be applied over the polymeric barrier layer 450e to enhance resistance to moisture or physical damage.

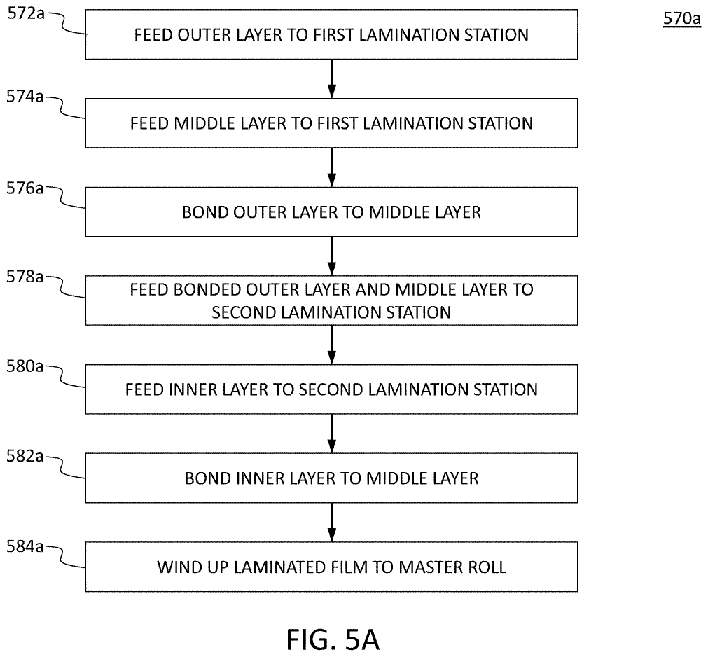

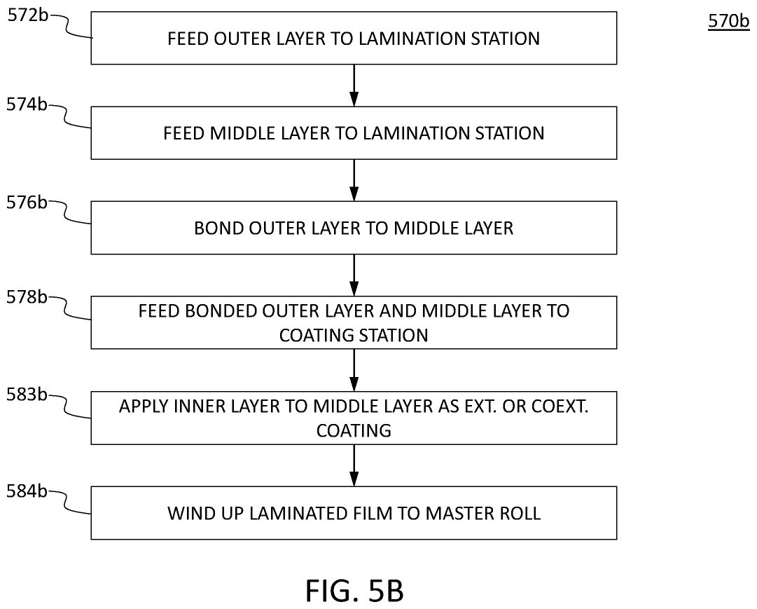

Referring now to FIG. 5A, there is shown a flow chart outlining a first exemplary method 570a for making the film structure 100 in accordance with the present disclosure. At step 572a, a first film ply comprising the outer layer 110 is fed to a first lamination station. As step 574a, a second film ply comprising the middle layer 120 is fed to the first lamination station. The first lamination station may be an adhesive lamination station or an extrusion lamination station.

At step 576b, the first and second plies are laminated to form an intermediate film structure comprising the outer layer 110 and the middle layer 120. At step 578a, the intermediate structure is fed to a second lamination station and at step 580a, a third film ply comprising the inner layer 130 is fed to the second lamination station. At step 582a, the intermediate structure and the third ply are laminated to form the film structure 100. At step 584a, the film structure 100 is wound up on a master roll, e.g., for subsequent processing, slitting into narrower rolls, storage, or transportation to a converter for further use. It will be recognized that variations of the illustrated method 570a are also possible. For example, in alternative embodiments, the middle layer 120 and inner layer 130 may be laminated to form an intermediate structure wherein the outer layer 110 is subsequently laminated to the intermediate structure. In still further embodiments, the outer, middle, and inner layers may be bonded together in a single-step lamination process, wherein all three layers are simultaneously aligned and passed through a lamination station, wherein the bonding material (e.g., adhesive or molten polymer) is applied to the required surfaces of the layers prior to lamination.

Referring now to FIG. 5B, there is shown a flow chart outlining a second exemplary method 570b for making the film structure 100 in accordance with the present disclosure. At step 572b, a first film ply comprising the outer layer 110 is fed to a lamination station. As step 574b, a second film ply comprising the middle layer 120 is fed to the lamination station. The lamination station may be an adhesive lamination station or an extrusion lamination station.

At step 576b, the first and second plies are laminated to form an intermediate film structure comprising the outer layer 110 and the middle layer 120. At step 578b, the intermediate structure is fed to a coating station and at step 583a, the inner layer 130 is brought onto the inward facing surface of the middle layer 120 as one or more molten polymers. The molten polymer(s) may be a single layer applied through a die (extrusion coating) or two or more layers applied simultaneously through a coextrusion die (coextrusion coating) . . . . At step 584b, the film structure 100 is wound up on a master roll, e.g., for subsequent processing, slitting into narrower rolls, storage, or transportation to a converter for further use. It will be recognized that variations of the illustrated method 570a are also possible. For example, in alternative embodiments, the middle layer 120 may be coated with the inner layer 130 to form an intermediate structure wherein the outer layer 110 is subsequently laminated to the intermediate structure.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1. A high toughness, puncture resistant, recyclable, polyolefin-based film structure comprising:
an outer layer having a first surface and a second surface opposite the first surface, the outer layer formed of one of (a) a machine direction oriented polyolefin-based film; and (b) a biaxially oriented polar polymer film;
a middle layer having a first surface and a second surface opposite the first surface, the middle layer formed of the other one of (a) the machine direction oriented polyolefin-based film; and (b) the biaxially oriented polar polymer film;
a first bonding interlayer bonding the second surface of the outer layer to the first surface of the middle layer; and
an inner layer having a first surface and a second surface opposite the first surface, the first surface of inner layer bonded to the second surface middle layer, the inner layer comprising a polyolefin-based polymer, wherein at least the second surface of the inner layer is heat sealable, and wherein the second surface of the inner layer defines an innermost surface of the laminated film.

2. The film structure of claim 1, wherein the film structure comprises between 70% and 99% by weight of one or more polyolefin-based polymers.

3. The film structure of claim 1, wherein:
the machine direction oriented polyolefin-based film is a uniaxially oriented polyolefin-based film which has been stretched in the machine direction at a draw ratio in the range of 3:1 to 10:1; and
the biaxially oriented polar polymer film is a film which has been stretched in the machine direction at a draw ratio in the range of 3:1 to 10:1 and in the transverse direction at a draw ratio in the range of 3:1 to 10:1.

4. The film structure of claim 3, wherein:
the machine direction oriented polyolefin-based film defines a directional tear layer having a directional tear characteristic in a direction parallel to the machine direction and a tear resistance in the machine direction of less than 100 gf/ml when tested according to ASTM D1922;
the biaxially oriented polar polymer film defines a puncture resistant layer having a puncture resistant characteristic and a maximum puncture force in the range of 15 N to 60 N when tested according to ASTM F1306; and
the film structure has a maximum puncture force in the range of 20 N to 70 N when tested according to ASTM F1306.

5. The film structure of claim 1, wherein the first bonding interlayer is selected from the group consisting of an adhesive layer and an extrusion interlayer.

6. The film structure of claim 1, further comprising a second bonding interlayer bonding the second surface of the middle layer to the first surface of the inner.

7. The film structure of claim 1, wherein the second bonding interlayer is selected from the group consisting of an adhesive layer and an extrusion interlayer.

8. The film structure of claim 1, wherein the inner layer is selected from then group consisting of an extruded film layer, a coextruded film layer, an extrusion coating layer, and a coextrusion coating layer.

9. The film structure of claim 1, wherein the polyolefin-based sealant layer comprises a polymer selected from the group consisting of polyethylene (PE), polypropylene (PP), polyolefin blends, polyolefin copolymers, low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymer (COC), cast polypropylene (CPP), ethylene-propylene copolymer (EPC), monoaxially- and biaxially-oriented polyolefins, biaxially oriented polypropylene (BOPP), and other polyolefin materials, post-consumer recycled (PCR) polyolefins, as well as blends, coextrusions, and laminations of any of the foregoing.

10. The film structure of claim 1, wherein the inner layer is a nonbarrier film layer.

11. The film structure of claim 1, wherein the inner layer comprises:
an outer sealant layer comprising a polyolefin-based polymer;
a core barrier layer; and
an inner sealant layer comprising a polyolefin-based polymer.

12. The film structure of claim 11, wherein the core barrier layer is selected from the group consisting of a polyvinyl alcohol (PVOH) layer, an ethylene vinyl alcohol copolymer (EVOH) layer, a polyamide layer, a nylon layer, or a combination thereof.

13. The film structure of claim 12, further comprising a first tie layer disposed intermediate the outer sealant layer and the core barrier layer and a second tie layer disposed intermediate the core barrier layer and the inner sealant layer.

14. The film structure of claim 1, wherein the inner layer comprises a polyolefin-based sealant layer having a barrier coating layer deposited thereon, and optionally wherein the barrier coating layer is selected from:
an inorganic barrier coating selected from the group consisting of an aluminum oxide (AlOx) coating layer, a silicon oxide (SiOx) coating layer, and a metallized deposition layer; and
a polymeric barrier coating comprising polyvinyl alcohol.

15-16. (canceled)

17. The film structure of claim 1, further comprising one or both of:
a middle layer barrier disposed on one or both of the first surface of the middle layer and the second surface of the middle layer; and
an outer layer barrier disposed on one or both of the first surface of the outer layer and the second surface of the outer layer.

18. The film structure of claim 17, the middle layer barrier and the outer layer barrier each independently comprise an inorganic barrier material or a polymeric barrier material, wherein at least one of the middle layer barrier and the outer layer barrier comprises a barrier material.

19. The film structure of claim 17, wherein the middle layer barrier is selected from the group consisting of ethylene vinyl alcohol copolymer (EVOH), polyvinyl alcohol (PVOH), an inorganic oxide, silicon oxide (SiOx), aluminum oxide (AlOx), a metallization layer, and a metallized aluminum layer, and wherein the outer layer barrier is selected from the group consisting of polyvinyl alcohol (PVOH), an inorganic oxide, silicon oxide (SiOx), aluminum oxide (AlOx), a metallization layer, and a metallized aluminum layer.

20. The film structure of claim 1, further comprising one or both of a printed ink layer and a coating layer disposed on the first surface of the outer layer, and optionally wherein the coating layer is selected from the group consisting of a two-part coating and an energy cured coating.

21. (canceled)

22. The film structure of claim 1, further comprising a printed ink layer selected from the group consisting of:
a forward printed ink layer disposed on the first surface of the outer layer;
a reverse printed ink layer disposed on the second surface of the outer layer;
a forward printed ink layer disposed on the first surface of the middle layer;
a reverse printed ink layer disposed on the second surface of the middle layer;
a forward printed ink layer disposed on the first surface of the inner layer; and
any combination thereof.

23. The film structure of claim 1, wherein the biaxially oriented polar polymer film is selected from the group consisting of biaxially oriented nylon (BON), cast nylon, oriented polyethylene terephthalate (OPET), and biaxially oriented polyethylene terephthalate (BOPET), and 32 gauge biaxially oriented nylon (BON) film.

24-25. (canceled)

26. The film structure of claim 1, wherein the machine direction oriented polyolefin-based film is selected from the group consisting of a machine direction oriented polyethylene film and a machine direction oriented polyolefin-based film having a thickness of about 1 mil.

27. (canceled)

28. A packaging article formed of the film structure according to claim 1.
